(19) United States
(12) Patent Application Publication
(10) Pub. No.: US 2015/0187252 A1
(43) Pub. Date: Jul. 2, 2015

(54) DRIVING METHOD OF DISPLAY APPARATUS AND DISPLAY APPARATUS

(71) Applicant: SAMSUNG DISPLAY CO., LTD., Yongin-City (KR)

(72) Inventors: Ryo ISHII, Yokohama (JP); Daisuke KAWAE, Yokohama (JP)

(21) Appl. No.: 14/579,070

(22) Filed: Dec. 22, 2014

(30) Foreign Application Priority Data
Dec. 27, 2013 (JP) 2013-272098

(51) Int. Cl. G09G 3/20; G09G 3/32

(52) U.S. Cl. CPC G09G 3/2007; G09G 3/3258; G09G 2320/0233; G09G 2320/064; G09G 2300/0819

(57) ABSTRACT

A display apparatus includes a scan line driving circuit and a data line driving circuit. The scan line driving circuit supplies a scan signal to exclusively select scan lines in each of a plurality of horizontal periods. The data line driving circuit provides the data lines with data signals for turning on or off associated pixel circuits. An image on a display screen for displaying a plurality of gray scale values is displayed by switching the pixel circuits to an on state or an off state in each of a plurality of sub-frames in one frame. A pulse width of the sub-frame is set by one or more of the horizontal periods. The number of horizontal periods of a pulse width of each of the sub-frames is set such that a remainder is 1 horizontal period when a number of horizontal periods is divided by a number of the sub-frames.

### CROSS-REFERENCE TO RELATED APPLICATION

Japanese Patent Application No. 2013-272098, filed on Dec. 27, 2013, and entitled: “Driving Method of Display Apparatus and Display Apparatus,” is incorporated by reference herein in its entirety.

### BACKGROUND

1. Field

One or more embodiments described herein relate to a driving method of a display apparatus and a display apparatus.

2. Description of the Related Art

Organic electro-luminescence displays and organic light emitting diode (OLED) displays have pixels which emit light with brightness corresponding to supplied current.

A sub-frame driving method has been used to drive these types of displays. In this method, a frame is divided into a plurality of sub-frames. Light of a certain gray scale value is then displayed by setting a light-emitting element to an on state or an off state during each sub-frame, such that duration (rate) of a time when a pixel is turned on during one frame is changed. The sub-frame driving method may reduce display unevenness due to variation in the potential of a gate terminal of the driving transistors of the pixels, or may reduce variation in the characteristics of the driving transistors.

However, when the sub-frame driving method is used, precise setting of driving timing based on the number of gray scale bits or the number of scan lines is necessary to display a gray scale value more exactly.

### SUMMARY

In accordance with one embodiment, a method of driving a display apparatus which includes a plurality of pixel circuits corresponding to a plurality of data lines and a plurality of scan lines, a scan line driving circuit to supply a scan signal to each of the scan lines to exclusively select the scan lines in each of a plurality of horizontal periods, and a data line driving circuit to provide the data lines with data signals for turning on or off the pixel circuits to supply the data signal to a selected pixel circuit connected to one selected from the scan lines, and to display an image on a display screen with a plurality of gray scales by switching the pixel circuits into an on state or an off state in each of a plurality of sub-frames in one frame.

The method includes setting a pulse width for the sub-frame by one or more of the horizontal periods; and setting a number of the horizontal periods in each of the sub-frames such that a remainder is 1 horizontal period when the number of horizontal periods is divided by the number of sub-frames.

When a predetermined number of horizontal periods of the sub-frame corresponds to 1 unit, the method may include setting sub-frames to correspond to the horizontal periods in the 1 unit, in each horizontal period a data signal of a corresponding sub-frame may be supplied to the data lines so as to be supplied to the selected pixel circuit connected to the selected scan line, and the 1 unit may be iterated sequentially in the frame.

When a number of scan lines is greater than a value of a number of gray scales plus 1, a number of units in the frame may be the number of scan lines. When the number of scan lines is not greater than a value of a number of gray scales plus 1, a number of units in the frame may be set with a value of a number of scan lines plus 1.

When a value of the number of units in the frame minus 1 is not an integer multiple of the number of gray scales, and the pixel circuits may always be turned off in one of the plurality of sub-frames.

A pulse width of the one of the plurality of sub-frames where the pixel circuits are always turned off may be set with a horizontal period corresponding to pulse widths of remaining sub-frames other than the sub-frame, in which the pixel circuits are always turned off, minus a product of the number of units in the frame and the number of sub-frames in the frame.

In accordance with another embodiment, a display apparatus includes a plurality of pixel circuits corresponding to a plurality of data lines and a plurality of scan lines; a scan line driving circuit to supply a scan signal to each of the scan lines to exclusively select the scan lines in each of a plurality of horizontal periods; and a data line driving circuit to provide the data lines with data signals for turning on or off the pixel circuits, each of the data signals to be supplied to a selected pixel circuit connected to a selected one of the scan lines, wherein an image on a display screen for displaying a plurality of gray scale values is displayed by switching the pixel circuits to an on state or an off state in each of a plurality of sub-frames in one frame; a pulse width of the sub-frame is set by one or more of the horizontal periods; and the number of horizontal periods of a pulse width of each of the sub-frames is set such that a remainder is 1 horizontal period when a number of horizontal periods is divided by a number of the sub-frames.

When a few of horizontal periods of the sub-frame is defined as 1 unit, sub-frames corresponding to horizontal periods in the 1 unit may be set, and in each horizontal period a data signal of a corresponding one of the sub-frames may be supplied to the data lines, so as to be supplied to the selected pixel circuit connected to the selected scan line, and the 1 unit is iterated sequentially in the frame.

In accordance with another embodiment, a method for driving a display apparatus includes setting a pulse width in a number of sub-frames of a frame based on a number of horizontal periods, a scan signal to be supplied to exclusively select at least one scan line of a plurality of scan lines in each of the horizontal periods; and setting the number of the horizontal periods based on a pulse width of each of the sub-frames, the number of horizontal periods set to a value corresponding to a quotient generated by dividing the number of horizontal periods by the number of sub-frames with a remainder is 1 horizontal period.

When a predetermined number of the horizontal periods corresponds to 1 unit, sub-frames corresponding to each of the horizontal period in the 1 unit may be set; and in each horizontal period a data signal of a corresponding sub-frame may be supplied to the data lines so as to be supplied to the selected pixel circuit connected to the selected scan line. The method may further include sequentially iterating the 1 unit in the frame.

When a number of scan lines is greater than a value of a number of gray scales plus 1, a number of units in the frame may correspond to the number of scan lines. When the number of scan lines is not greater than a value of a number of gray scales plus 1, a number of units in the frame may be set with a value of a number of scan lines plus 1.

When a value of the number of units in the frame minus 1 is not an integer multiple of the number of gray scales, pixel circuits may always be turned off in one of the plurality of sub-frames. A pulse width of the sub-frame in which the pixel circuits are always turned off may be set with a horizontal period corresponding to pulse widths of remaining sub-frames other than the sub-frame, in which the pixel circuits are always turned off, minus a product of the number of units in the frame and the number of sub-frames in the frame.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display apparatus;

FIG. 2 illustrates an embodiment of a pixel circuit;

FIG. 3 illustrates a timing sequence for one embodiment of a method for driving a display apparatus;

FIG. 4 illustrates a timing sequence for an embodiment of a method for driving a display apparatus;

FIG. 5 illustrates a setting result relating to driving timing of a display apparatus according to one embodiment;

FIG. 6 illustrates driving timing of a display apparatus according to one embodiment;

FIG. 7 illustrates a variation in the selection of a scan line in a display apparatus according to one embodiment;

FIG. 8 illustrates a timing sequence for another embodiment of a display apparatus;

FIG. 9 illustrates a setting result of a driving timing of a display apparatus according to another embodiment; and

FIG. 10 illustrates a variation in the selection of a scan line of a display apparatus according to another embodiment.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawings, the dimensions of layers and regions may be exaggerated for clarity of illustration. Like reference numerals refer to like elements throughout.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

The following embodiments are described for an organic EL display having an organic EL element as a light-emitting element. In other embodiments, another type of display apparatus may be used, including but not limited to any one having light-emitting elements (e.g., inorganic EL element) emitting light as current flows, or a display device (e.g., liquid crystal display) to which a sub-frame driving method is applied.

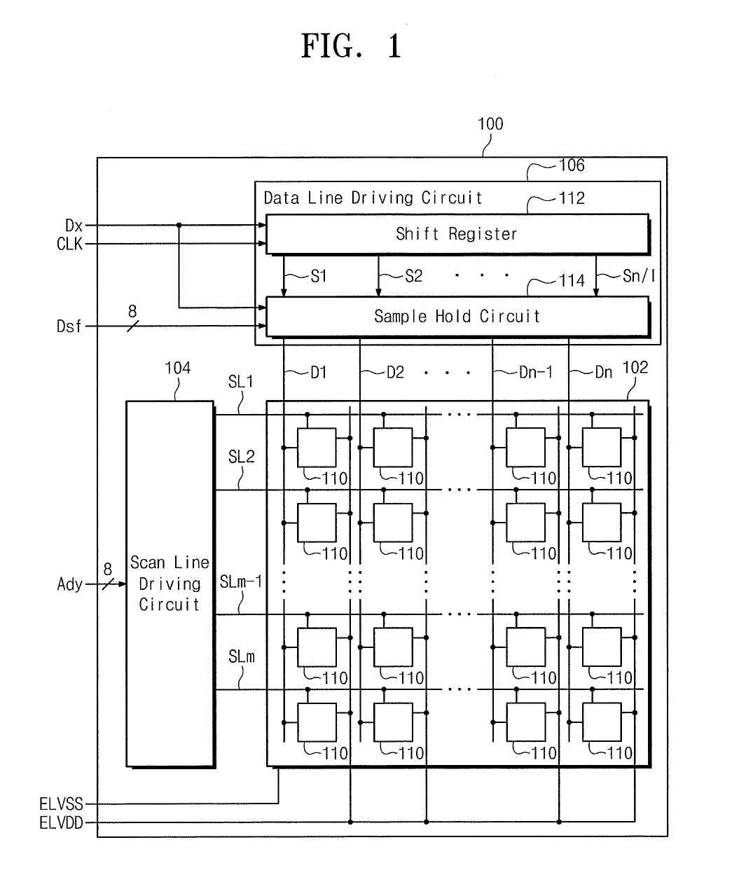

FIG. 1 illustrates an embodiment of a display apparatus 100 which includes a display unit 102, a scan line driving circuit 104, and a data line driving circuit 106. The display unit 102 has a plurality of pixel circuits 110 and displays an image corresponding to a data signal on a display screen. The pixel circuits 110 are disposed in the form of matrix at intersections of scan lines SL1 through SLm extending in a row direction and data lines D1 through Dn extending in a column direction.

One of the m scan lines SL1 through SLm may be referred to as “scan line SLi” (i being an integer greater than or equal to 1 and less than or equal m), and one of the n data lines D1 through Dn may be referred to as “data line Dj” (j being an integer greater than or equal to 1 and less than or equal n).

The display unit 102 is supplied with a power supply voltage ELVDD and a power supply voltage ELVSS, for example, from an upper control circuit of a timing controller. The power supply voltages ELVDD and ELVSS are signals for supplying current that causes a light-emitting element of the pixel circuits 110 to emit light.

The current that makes a pixel circuit 110 emit light may be, for example, a current value for inducing white luminance emission, by making all light-emitting elements emit light during one frame period. The power supply voltage ELVDD is supplied to each pixel circuit 110 through a power line. The power supply voltage ELVSS is supplied to each pixel circuit 110 through a common electrode.

The scan line driving circuit 104 is connected to the scan lines SL1 through SLm and supplies scan signals to the scan lines SL1 through SLm, respectively. As the scan line driving circuit 104 supplies a scan signal to each of the scan lines SL1 through SLm, the scan lines SL1 through SLm are exclusively selected every horizontal period.

For example, the scan line driving circuit 104 exclusively outputs a low-level scan signal to a scan line SLi of a row that is selected by an address Ady from a control circuit. The scan line driving circuit 104 may include, for example, an address decoder. In FIG. 1, the address Ady is illustrated to be 8-bit data. The address Ady may have a different number of bits in another embodiment.

The data line driving circuit 106 is connected to the data lines D1 through Dn, and supplies a data signal to the data lines D1 through Dn. The data signal is then supplied to a pixel circuit 110 (e.g., a selection pixel circuit) connected to the selected scan line SLi. For example, the data line driving circuit 106 samples display data Dsf supplied from the control circuit and supplies a data signal to the data lines D1 to Dn. In FIG. 1, the display data Dsf is 8-bit data. In another embodiment, the display data Dsf may be data having a different number of bits.

In one embodiment, the data signal is a signal that turns on or off a pixel circuit 110, for example. For example, the data signal may be a signal indicating a data bit of a high level or a low level. The data signal may be referred to as data bit.

The data line driving circuit 106 includes a shift register circuit 112 and a sample hold circuit 114. Upon starting a period where a scan line corresponding to one row is selected by the address Ady, the shift register circuit 112 sequentially shifts a horizontal synchronization signal Dx from the control circuit in synchronization with a clock signal CLK. The shift register circuit 112 narrows a width of a shifted signal to have half the period of the clock signal CLK and transfers sampling signals (S1 through Sn)/I of a high level to the sample hold circuit 114 sequentially and exclusively. Here, “I” indicates the number of data lines selected by the sample hold circuit 114 at a time.

The sample and hold circuit sequentially selects data lines in response to the sampling signals (S1 through Sn)/I from the shift register circuit 112 every block including the predetermined number I of data lines. For example, when the display apparatus 100 has 320 data lines and the predetermined number I is 8, the sample hold circuit 114 sequentially selects data lines in response to sampling signals S1 through S40 from the shift register circuit 112 every block including eight data lines.

The sample hold circuit 114 latches the display data from the control circuit. The sample hold circuit 114 simultaneously outputs data signals corresponding to data kept in synchronization with a horizontal synchronization signal Dx to the data lines D1 through Dn, while data corresponding to a row is held.

The display data Dsf is supplied from the control circuit. In a period where any scan line SLi is selected, the control circuit gathers and supplies display data, corresponding to pixel circuits of a row corresponding to a scan line SLi+1 to be next selected, in synchronization with a sampling signal by the block.

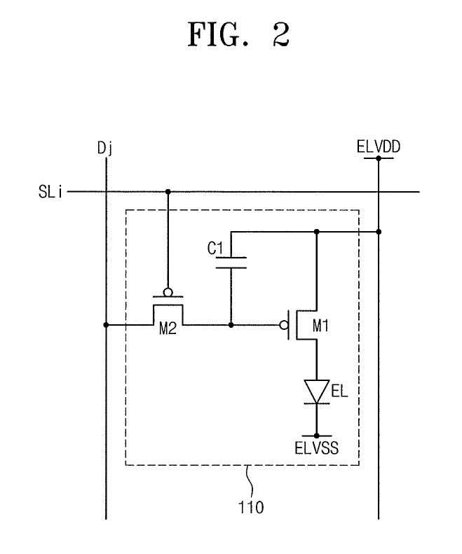

FIG. 2 illustrates an embodiment of a pixel circuit, which, for example, may correspond to pixel circuit 110 of the display apparatus 100. In FIG. 2, a pixel circuit 110 is show to be disposed at an intersection of a scan line SLi and a data line Dj, from among a plurality of pixel circuits 110 in a display unit 102 in FIG. 1. The other pixel circuits 110 of the display unit 102 may be configured substantially the same as in FIG. 2. In other embodiments, the pixel circuit 110 may have a different configuration.

The pixel circuit 110 includes a light-emitting element EL, a first switch element M1, a second switch element M2, and a capacitor C1. Here, a field effect transistor (FET) (e.g., Metal-Oxide-Semiconductor Field-Effect Transistor (MOSFET)) is exemplified as a switch element. Also, the first and second elements M1 and M2 are p-channel MOSFETs. In another embodiment, the switch element may be an n-channel MOSFET. If it is possible to perform the same role as the first and second switch elements M1 and M2, a switch element according to an embodiment may be any type of transistor, without being limited to the FET. Also, if it is possible to perform the same role as the first and second switch elements M1 and M2, a switch element according to one embodiment may be formed of another type of circuit element. For illustrative purposes only, the first and second switch elements M1 and M2 are p-channel MOSFETs in the following embodiment.

The first switch element M1 has a drain connected to an anode of the light-emitting element EL and a source connected to a power supply voltage ELVDD. The first switch element M1 is turned on or off in response to a data bit (or, a data signal) transferred to its gate through a data line Dj and the second switch element M2. The second switch element M2 has a source connected to the data line Dj and a drain connected to the gate of the first switch element M1. The second switch element M2 is turned on or off in response to a scan signal transferred to its gate through a scan line SLi.

The capacitor C1 holds a potential of a gate of the first switch element M1. A capacitor having a predetermined capacitance may be used as the capacitor C1, for example. The capacitor C1 may be a parasitic capacitor, for example.

In one embodiment, when a scan signal transferred from a scan line SLi transitions from a high level to a low level, the second switch element M2 is turned on. At this time, a data bit transferred from the data line Dj is supplied to the pixel circuit 110. The data bit may be a high-level or low-level signal. The second switch element M2 is turned off when the scan signal transferred from the scan line SLi transitions from a low level to a high level. At this time, a data bit from the data line Dj is held by the capacitor C1.

In the pixel circuit 110, a light-emitting state of a light-emitting element E1 is controlled as the first switch element M1 is selectively turned on in response to a signal level of a data bit transferred from the data line Dj and held in the capacitor C1. For example, when a signal level of a data bit held in the capacitor C1 is a high level, the first switch element M1 is turned off. In this case, since no current flows to the light-emitting element EL, the light-emitting element EL does not emit light. When a signal level of a data bit held in the capacitor C1 is a low level, the first switch element M1 is turned on. In this case, since current flows to the light-emitting element EL, the light-emitting element EL emits light.

In sub-frame driving, during each of sub-frames in one frame, the display apparatus 100 sets a data bit supplied to the data line Dj to a high level or a low level to control a light-emitting or non-light-emitting state of the pixel circuit 110. This is performed to display light of a certain gray scale value.

In one embodiment, a frame refers to a unit period for expressing, for example, gray scale values of light from all or a predetermined number of pixel circuits 110 of the display unit 102. The frame is of a predetermined duration, e.g., 16.7 ms corresponding to one period of a frame frequency of 60 Hz.

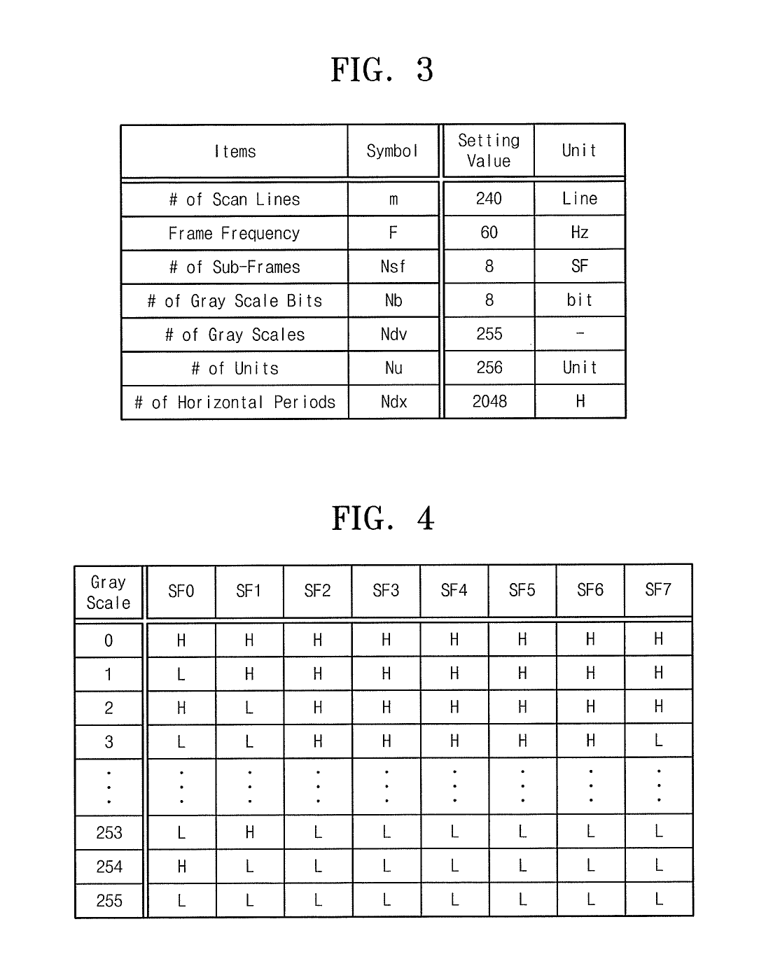

FIG. 3 illustrates a sequence of driving timing of the display apparatus 100 based on a driving method according to one embodiment. Referring to FIG. 3, in the driving method, it is assumed that the number m of scan lines is 240, the number Nsf of sub-frames is 8, the number of gray scale bits is 8, and a display apparatus 100 displays light in a gray scale range having 256 levels. Eight sub-frames are designated by “SF0”, “SF1” . . . “SF7”. A mapping exists between data bits of each sub-frame and bits of 8-bit gray scale data in each pixel circuit 110.

FIG. 4 illustrates a sequence of driving timing of the display apparatus 100 based on a driving method according to one embodiment. In FIG. 4, a mapping is provided between data bits of each sub-frame and bits of 8-bit gray scale data in each pixel circuit 110. For example, in FIG. 4, SF0 corresponds to a least significant bit (LSB) and SF7 corresponds to a most significant bit (MSB).

Ideal time weighting about sub-frames SF0 through SF7 in one frame may be designated by “WI₀” through “WI₇” The ideal time weighting about the sub-frames SF0 through SF7 in one frame may be determined based on Equation 1, where k is an integer greater than or equal to 0 and less than or equal to (Nsf−1).

W|ₖ=2^{k} (1)

In Equation 1, the integer of k is a number indicating a position of a sub-frame, and a number indicating a position of a sub-frame is designated by SFk.

According to Equation 1, the ideal weightings WI₀, WI₁, WI₂ . . . WI₇ of sub-frames are 1, 2, 4 . . . 128. The number Ndv of gray scales belonging to one frame is a total sum of ideal weightings. Thus, the number Ndv of gray scales belonging to one frame, for example, may be calculated by Equation 2.

$$Ndv = {\sum }_{k = 0}^{Nsf - 1} {WI}_{k} \qquad ( 2 )$$

In Equation 2, the number Ndv of gray scales belonging to one frame is 255.

A relationship between the number m of scan lines and the number Ndv of gray scales may be based on Equation 3.

m [symbol] Ndv+1 (3)

In one embodiment, a unit is defined by: a horizontal period where the number of data signals (data signals corresponding to SF0 through SF(Nsf−1)) corresponds to the number Nsf of sub-frames being continuative.

When a condition corresponding to Equation 3 is satisfied, the number Nu of units per frame may be determined based on Equation 4.

Nu=m (4)

When a condition corresponding to Equation 3 is satisfied, one frame is divided into m uniform periods, and each period thus divided corresponds to one unit.

When a condition corresponding to Equation 3 is not satisfied, the number Nu of units per frame may be determined based on Equation 5.

Nu=Ndv+1 (5)

When a condition corresponding to Equation 3 is not satisfied, one frame is divided into (Ndv+1) uniform periods, and each period thus divided corresponds to one unit. In one embodiment, the number Nu of units per frame may be 256 because the number m of scan lines is 240 (refer to FIG. 3) and the number Ndv of gray scales per frame is 255 (refer to Equation 2).

As described above, in one embodiment, obtaining the number Nu of units per frame may mean setting weighting of each sub-frame by the unit. Thus, weighting of a sub-frame may be minimal with respect to one unit [Unit].

When a condition corresponding to Equation 3 is not satisfied, “1” is added to the number Ndv of gray scales in Equation 5. However, this addition is performed to use one unit added for adjustment of rewriting timing. Thus, even though the number m of scan lines and the number Ndv of gray scales vary, it is possible to temporarily determine the rewriting timing of each sub-frame by a period according to the adjustment.

When a condition corresponding to Equation 3 is satisfied, “1” is not added to the number m of scan lines in Equation 4. In Equation 4, the reason why “1” is not added to the number m of scan lines is that a period according to the adjustment is already involved, because a condition corresponding to Equation 3 is satisfied and the number m of scan lines is greater than the number Ndv of gray scales.

The number Ndx of horizontal periods per frame may be determined based on Equation 6.

Ndx=Nu×Nsf (6)

When one unit is divided by the number Nsf of sub-frames to have a uniform period and each period thus divided is defined as “1[H]”, the number Ndx of horizontal periods per frame is 2048[H].

Also, an ideal pulse width PIₖ of a horizontal period unit of each sub-frame may be determined based on Equation 7. In Equation 7, to round off to the nearest whole number, “0.5” is added to a right hand side, and the decimals are discarded.

$${PI}_{k} = [ \frac{( Nu - 1 ) \times Nsf \times {WI}_{k}}{Ndv} + 0.5 ] \qquad ( 7 )$$

According to Equation 7, ideal pulse widths of the horizontal period unit about sub-frames are as follows. PI₀=8[H], PI₁=16[H], PI₂=32[H], PI₃=64[H], PI₄=128[H], PI₅=256[H], PI₆=512[H], and PI₇=1024[H].

A pulse width PUₖ to be practically applied to a unit of each sub-frame may be determined based on Equation 8, based on the ideal pulse width PIₖ determined by Equation 7.

$${PU}_{k} = [ \frac{{PI}_{k}}{Nsf} ] \qquad ( 8 )$$

According to Equation 7, practical unit-based pulse widths of the sub-frames are as follows. PU₀=1[Unit], PU₁=2[Unit], PU₂=4[Unit], PU₃=8[Unit], PU₄=16[Unit], PU₅=32[Unit], PU₆=64[Unit], and PU₇=128[Unit].

A pulse width PHₖ to be practically applied to a horizontal period unit of each sub-frame may be determined based on Equation 9, based on the practical pulse width PUₖ determined by Equation 8.

PHₖ=PUₖ×NSf+1 (9)

According to Equation 9, practical unit-based pulse widths of the horizontal period unit of the sub-frames are as follows. PH₀=9[H], PH₁=17[H], PH₂=33[H], PH₃=65[H], PH₄=129[H], PH₅=257[H], PH₆=513[H], and PH₇=1025[H].

As illustrated in Equation 9, since 1[H] is added to a product of a practical unit-based pulse width PUₖ and the number Nsf of sub-frames, rewriting timing of each sub-frame in each unit is fixed as follows: k=0, k=1, k=2 . . . k=7. When a driving method of a display apparatus according to the present embodiment is used, a corresponding scan line SL may be selected, for example, in the order of SF0, SF1, SF2 . . . SF7 in each unit. One embodiment of a scan line selecting operation of a display apparatus will be described later.

Scan timing SSₖ of a scan line SL1 of a first row may be determined based on Equation 10, based on a practical pulse width PHₖ of a horizontal period unit of each sub-frame determined based on Equation 9.

$$\{ \begin{matrix}{SS}_{0} = 0 ( k = 0 ) \\ {SS}_{k} = {PH}_{k - 1} + {SS}_{k - 1} ( K ≻ 0 )\end{matrix} \qquad ( 10 )$$

According to Equation 10, scan timing SSₖ of the scan line SL1 of the first row is as follows: SS₀=0[H], SS₁=9[H], SS₂=26[H], SS₃=59[H], SS₄=124[H], SS₅=253[H], SS₆=510[H], and SS₇=1023[H].

In each unit, a scan line SLk each sub-frame selects is determined according to the scan timing SSₖ of the scan line SL1 of the first row determined according to Equation 10.

For example, first, a condition expressed by Equation (11) is defined using a unit number Un satisfying the following requirement: 0≦Un≦255.

$$Un - \frac{{SS}_{k} - k}{Nsf} \geq 0 \qquad ( 11 )$$

When a condition corresponding to Equation 11 is satisfied, a scan line SLk each sub-frame selects may be determined based on Equation 12 in each unit.

$${SL}_{k} = Un - \frac{{SS}_{k} - k}{Nsf} + 1 \qquad ( 12 )$$

When a condition corresponding to Equation 11 is not satisfied, a scan line SLk each sub-frame selects may be determined based on Equation 13 in each unit.

$${SL}_{k} = Un - \frac{{SS}_{k} - k}{Nsf} + Nu + 1 \qquad ( 13 )$$

When a driving method of a display apparatus according to the present embodiment is used, a display apparatus 100 sequentially shifts timing defined at scan timing SSₖ of a scan line SL1 of a first row so as to be applied to all scan lines SL. Thus, the display apparatus 100 selects 256 scan lines (including 240 practical scan lines and 16 virtual scan lines) with constant timing. Equations 11 to 13 may correspond to conditions for resetting a row of a selected scan line SL when a selected scan line exceeds a 256^{th} scan line SL256. In the display apparatus 100, a scan line selection row may be determined based on Equations 11 through 13 in each sub-frame of each unit.

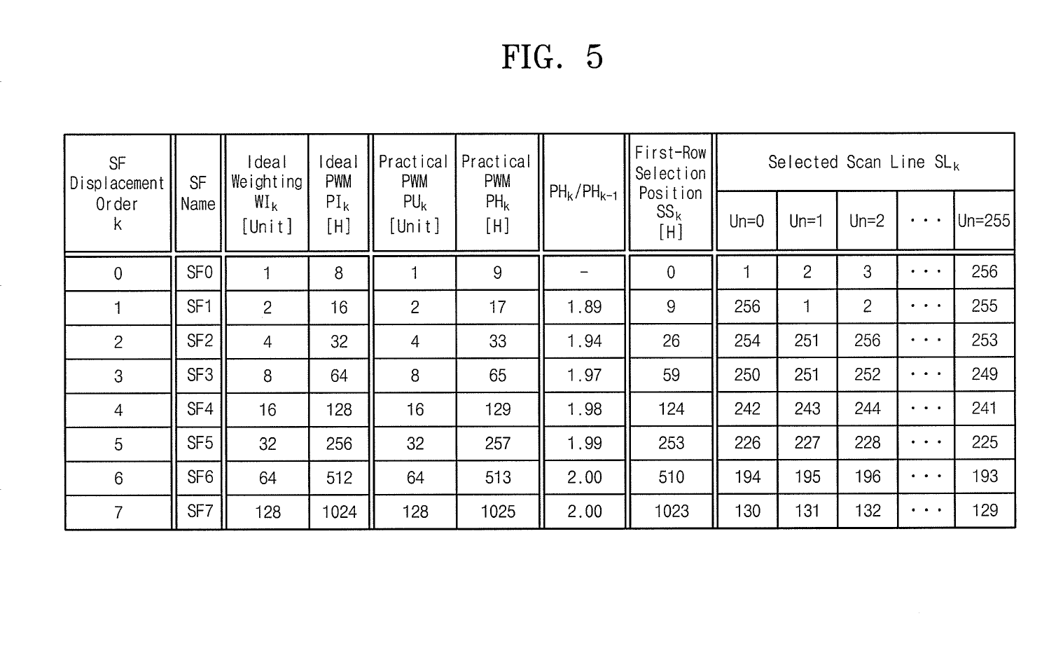

FIG. 5 illustrates an example describing a setting result of driving timing of the display apparatus 100 based on a driving method according to one embodiment. In FIG. 5, a first row selection position SS_{K} is stored at a storage medium (e.g., a memory). The display apparatus 100 reads the first row selection position SS_{K} stored at the storage medium to perform an operation based on the driving method: an operation for selecting a scan line SL.

As shown in FIG. 5, a ratio of pulse widths of adjacent sub-frames PHₖ/PHₖ₋₁ (k being greater than “0”) approximately corresponds to a ratio of ideal weighting WIₖ/WIₖ₋₁=2.0 (k being greater than “0”). Thus, the display apparatus 100 controls light-emitting luminance from a 0-level gray scale to a 255-level gray scale more exactly by appropriately adjusting data bits of each sub-frame according to a combination such as shown in FIG. 4.

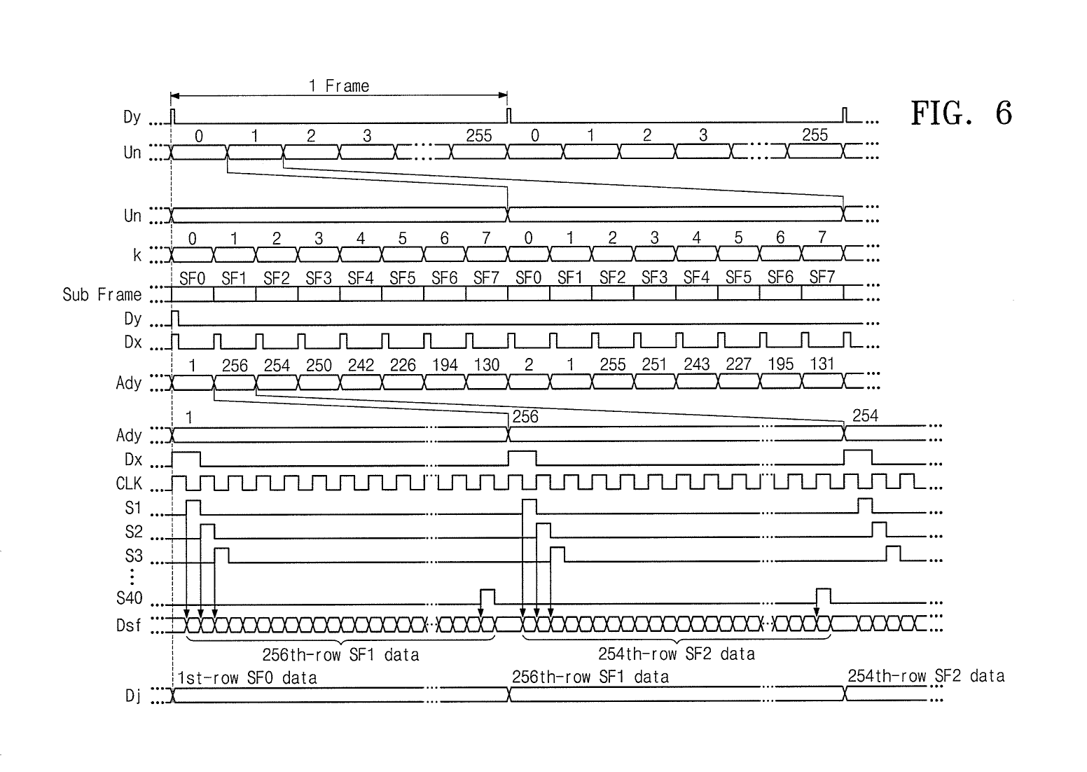

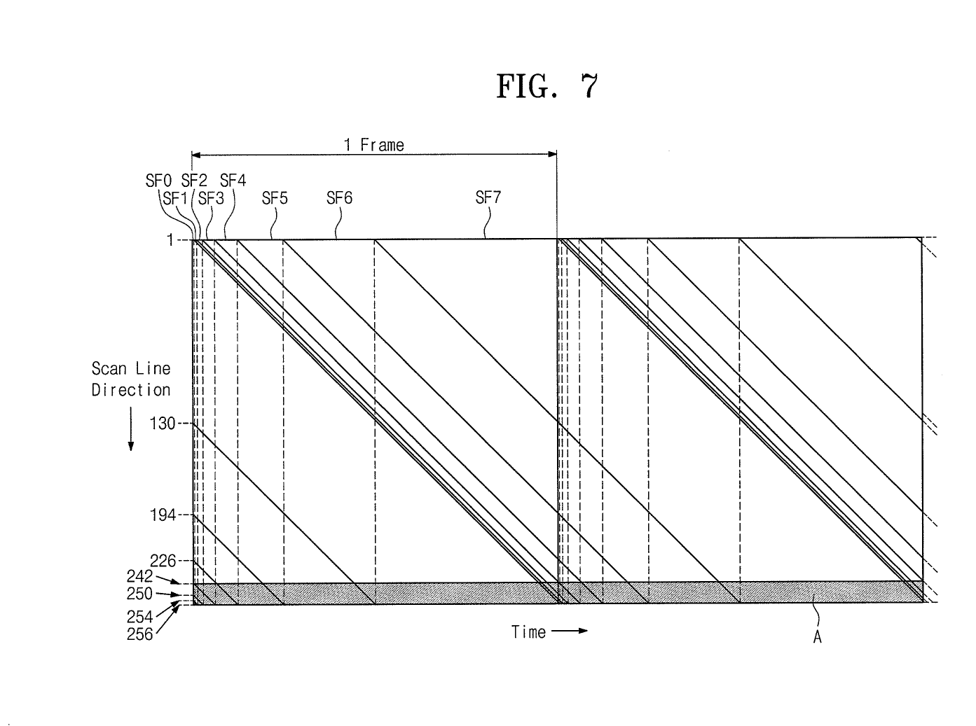

FIG. 6 illustrates an embodiment of driving timing in the display apparatus 100, and FIG. 7 illustrates a variation in selection of a scan line SL according to one embodiment. Here, FIG. 6 shows driving timing in the illustrative case of when a display apparatus 100 has 320 data lines D and 240 scan lines SL, a sample hold circuit 114 sequentially selects the data lines D in response to sampling signals S1 through S40 from a shift register circuit 112 every block including eight data lines D.

The display apparatus 100 increases a sub-frame displacement order k from 0 to 7 in synchronization with a horizontal synchronization signal Dx. If k reaches 7, the display apparatus 100 iteratively performs resetting to 0 in synchronization with the horizontal synchronization signal Dx.

The display apparatus 100 resets a unit number Un to 0 in synchronization with a vertical synchronization signal Dy and increases the unit number Un from 0 to 255 in synchronization with timing when the sub-frame displacement order k is reset to 0.

The display apparatus 100, as described above, sets 8[H] with 1[Unit] from k=0 to k=7.

Also, the display apparatus 100, as shown in FIG. 5, determines a scan line SLi, based on a setting result of driving timing. For example, data bits of a sub-frame SF0 are written in a 1 horizontal period where the unit number Un is 0 and the sub-frame displacement order k is 0. At this time, an address Ady is 1, and the display apparatus 100 selects a scan line SL1 of a first row. In this case, a scan line driving circuit 104 of the display apparatus 100 outputs a low-level scan signal to the scan line SL1.

For example, data bits of a sub-frame SF1 are written in a 1 horizontal period where the sub-frame displacement order k is 1. At this time, an address Ady is 256, and the display apparatus 100 selects a 256^{th} virtual scan line.

Likewise, data bits of a sub-frame SF0 are written in a 1 horizontal period where the unit number Un is 1 and the sub-frame displacement order k is 0. At this time, an address Ady is 2, and the display apparatus 100 selects a scan line SL2 of a second row. In this case, the scan line driving circuit 104 of the display apparatus 100 outputs a low-level scan signal to the scan line SL2.

As iterating the above-described operation, the display apparatus 100 sequentially shifts scan timing SSₖ of a scan line SL1 of a first row together with a variation in selection of a scan line of each sub-frame in one frame period shown in FIG. 7, so as to be applied to all scan lines SL1 through SLm. Also, in FIG. 7, a region corresponding to A is a region where virtual scan lines are selected and does not influence practical expression. A driving method having a different condition will how be described.

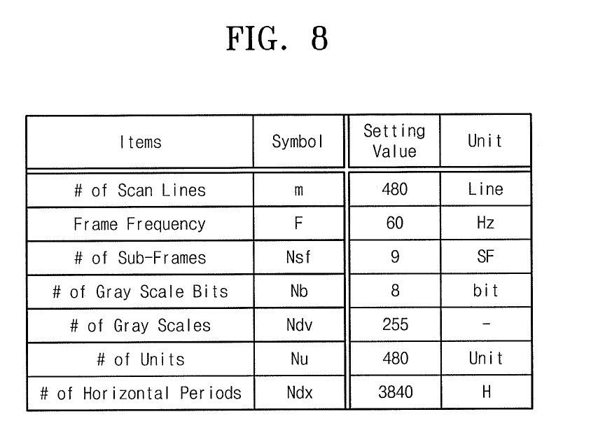

FIG. 8 illustrates a sequence of driving timing of a display apparatus according to another embodiment of a driving method. In this method, the number m of scan lines is 480[Line], the number Nb of gray scale bits is 8[bit], and the display apparatus 100 displays a gray scale with 256 levels. These values are provided to illustratively describe the case where a condition corresponding to Equation 3 is satisfied. Also, ideal weighting WIₖ of each sub-frame is illustratively provided as follows: WI₀=1, WI₁=2, WI₂=4 . . . WI₇=128 and the number Ndv of gray scales is 255.

According to Equations 3 and 4, the number Nu of units per frame is 480[Unit]. A relationship between the number Nu of units per frame and the number Ndv of gray scales may be determined based on Equation 14.

$$\frac{Nu - 1}{Ndv} - [ \frac{Nu - 1}{Ndv} ] \neq 0 \qquad ( 14 )$$

When a condition corresponding to Equation 14 is satisfied, that is, when (Nu−1) is not an integer multiple of the number Ndv of gray scales, the number Nsf of sub-frames is preferably a number that is obtained by adding a sub-frame for non-light-emitting 1[SF] to the number of sub-frames needed to display a gray scale.

Here, a condition corresponding to Equation 14 is satisfied may refer to the case where residual units not divided by weighting of each sub-frame occurs. If the residual units are used to emit light, a light-emitting ratio of one frame is in disorder. In this case, even though the display apparatus 100 controls data bits of each sub-frames in compliance with a combination shown in FIG. 4, it may be difficult to exactly control light-emitting luminance from a 0 level to a 255 level.

In a driving method of the present embodiment, a sub-frame for non-light-emitting is prepared and one or more residual units are assigned to the sub-frame for non-light-emitting. Also, during a period of the sub-frame for non-light-emitting, a high-level data bit is written at all pixels. For example, pixel circuits are always turned off in a sub-frame for non-light-emitting being one of a plurality of sub-frames. As described above, since a residual unit does not influence a light-emitting ratio of one frame in the display apparatus 100 using the present embodiment of the driving method, the display apparatus 100 exactly controls light-emitting luminance.

Also, in one embodiment, the number Nsf of sub-frames is 9[SF] because a sub-frame for non-light-emitting 1[SF] may be added to the number of sub-frames 8[SF] for displaying light of a certain gray scale value. Also, a sub-frame for non-light-emitting may be SF8, and ideal weighting WI8 may be set with 0.

No residual unit exists when a condition corresponding to Equation 14 is not satisfied. Thus, when a condition corresponding to Equation 14 is not satisfied, a sub-frame for non-light-emitting does not need to be prepared.

If an ideal pulse width PIₖ of a horizontal period unit of each sub-frame is set according to Equation 7, PI₀=8[H], PI₁=16[H], PI₂=32[H], PI₃=64[H], PI₄=128[H], PI₅=256[H], PI₆=512[H], PI₇=1024[H], and PI₀=0[H].

If a unit-based pulse width PUₖ of each sub-frame to be practically applied is set according to Equation 8, PU₀=1[Unit], PU₁=3[Unit], PU₂=7[Unit], PU₃=15[Unit], PU₄=30[Unit], PU₅=60[Unit], PU₆=120[Unit], and PU₇=240[Unit].

A sub-frame SF8 for non-light-emitting may be determined based on Equation 15.

$${PU}_{Nsf - 1} = Nu - 1 - {\sum }_{k = 0}^{Nsf - 2} {PU}_{k} \qquad ( 15 )$$

According to Equation 15, a practical pulse width PU8 of the sub-frame SF8 of non-light-emitting is 3.

If a pulse width PHₖ of a horizontal period unit of each sub-frame to be practically applied is set according to Equation 9, PH₀=10[H], PH₁=28[H], PH₂=64[H], PH₃=136[H], PH₄=271[H], PH₅=541[H], PH₆=1081[H], PH₇=2161[H], and PH₈=28[H]. Here, a pulse width PH₈ of a horizontal period unit of the sub-frame SF₈ for non-light-emitting to be practically applied corresponds to “a horizontal period defined by pulse widths of remaining sub-frames other than a sub-frame for non-light-emitting minus a product of the number Nu of units in one frame and the number Nfs of sub-frames of one frame, as understood from Equations 9 and 15.

If scan timing SSₖ of a scan line SL1 of a first row is set according to Equation 10, SS₀=0[H], SS₁=10[H], SS₂=38[H], SS₃=102[H], SS₄=238[H], SS₅=509[H], SS₆=1050[H], SS₇=2131[H], and SS₈=4292[H].

In one embodiment, because a scan line SLk for each sub-frame in each unit is selected according to Equations 11 through 13, a selection row of a scan line in each sub-frame of each unit may be determined.

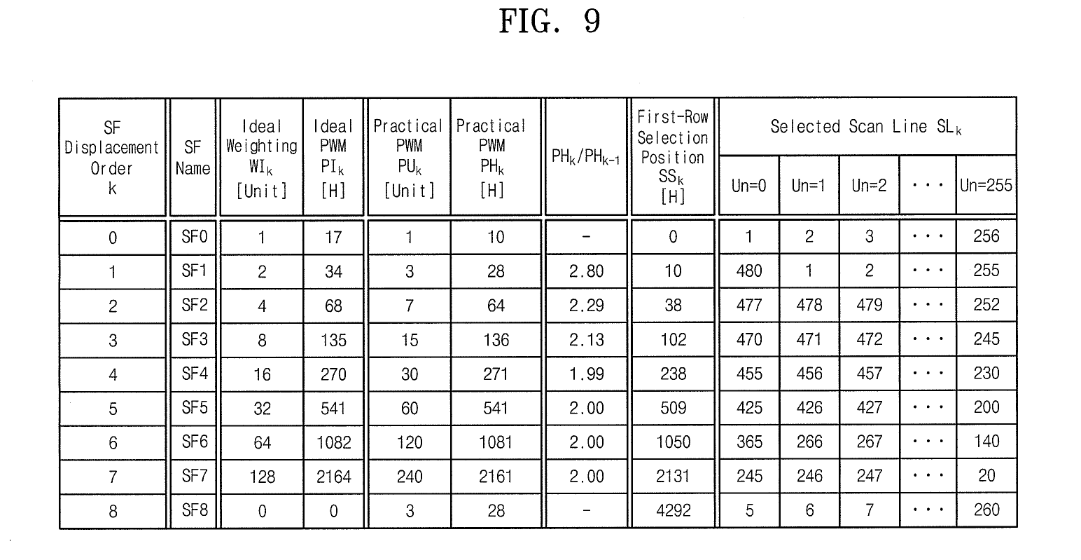

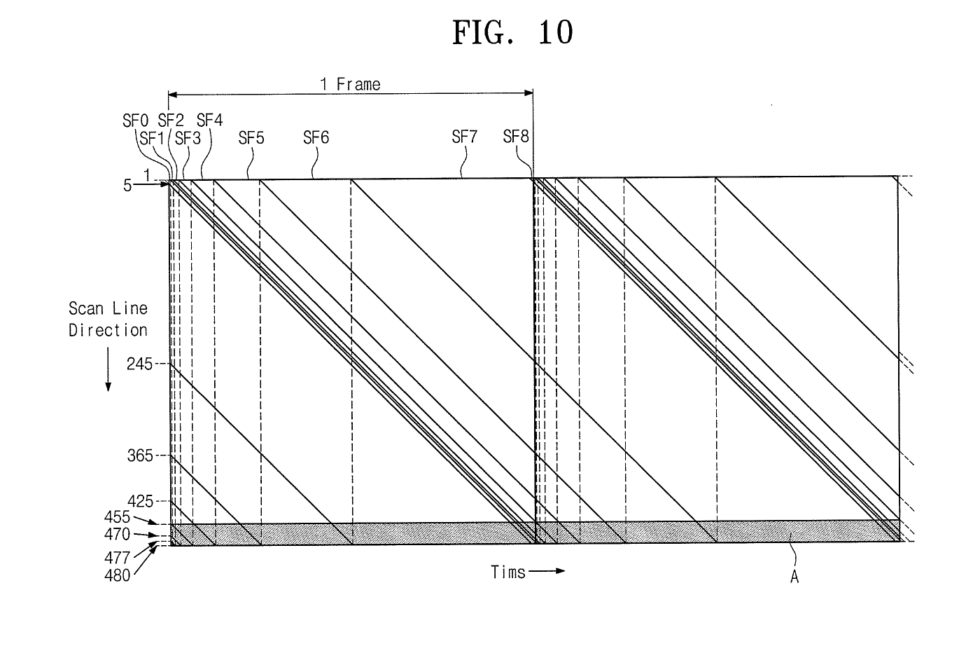

FIG. 9 illustrates a setting result of driving timing of a display apparatus according to another embodiment of a driving method. FIG. 10 illustrates a variation in the selection of a scan line SL in display apparatus 100 according to another embodiment.

As shown in FIG. 9, a ratio of pulse widths of adjacent sub-frames PHₖ/PHₖ₋₁ (k being greater than 0) approximately corresponds to a ratio of ideal weighting WIₖ/WIₖ₋₁=2.0 (k being greater than 0). Thus, the display apparatus 100 that uses a driving method of the present embodiment controls light-emitting luminance from a 0-level gray scale to a 255-level gray scale more exactly by appropriately adjusting data bits of each sub-frame according to a combination shown in FIG. 4.

Also, this embodiment sequentially shifts scan timing SSₖ of a scan line SL1 of a first row, together with a variation in selection of a scan line of each sub-frame in one frame period, as shown in FIG. 10, so as to be applied to all scan lines SL. Also, a high-level data bit are written at all pixels in a period corresponding to a sub-frame SF8. Thus, the period corresponding to the sub-frame SF8 does not influence practical expression.

Also, in at least one embodiment, weighting WIₖ of a sub-frame SFk is determined according to Equation 1, and sub-frames are disposed from LSB to MSB. In another embodiment, sub-frames may be disposed randomly. In at least one embodiment, weighting of each sub-frame is freely set after determining the number Ndv of gray scales and the number Nsf of sub-frames. In these or other embodiments, a display apparatus using a driving method of a display apparatus may set driving timing according to Equations 2 through 15.

In one or more embodiments, an image on a display screen with a plurality of gray scales is displayed by switching pixel circuits to an on state or an off state every sub-frame in one frame. A pulse width of the sub-frame is set by the horizontal period. The number of horizontal periods of a pulse width of each sub-frame is set such that a remainder is a 1 horizontal period when the number of horizontal periods is divided by the number of sub-frames. According to this configuration, when a sub-frame driving method is used, driving timing is set more appropriately regardless of the number of gray scale bits or the number of scan lines.

In one or more embodiments, a sub-frame for non-light-emitting is prepared when a condition corresponding to Equation 14 is satisfied. In other embodiments, a sub-frame of predetermined weighting may be prepared according to a characteristic of a light-emitting element EL or a characteristic of a gray scale to be displayed. In this case, a high-level data bit is written at all pixel circuits in a period corresponding to a sub-frame, thereby making it possible to use the sub-frame as a sub-frame for non-light-emitting.

As described above, if the number of scan lines, the number of sub-frames, a displacement order of sub-frames, and weighting of each sub-frame are determined through one or more embodiments of the driving method, driving timing may be determined without writing a plurality of sub-frames in one horizontal period and without replacing a displacement order of sub-frames. Thus, it is possible set driving timing more appropriately upon using of a sub-frame driving method, regardless of the number of gray scale bits or the number of scan lines.

Also, a display apparatus is provided which sets driving timing to control data bits of each sub-frame appropriately, thereby making it possible to control light-emitting luminance more exactly in a gray scale control range.

By way of summation and review, a sub-frame driving method may reduce influence of display unevenness due to a variation in the potential of a gate terminal of a driving transistor in each pixel or a characteristic variation of the driving transistor. However, when the sub-frame driving method is used, precise setting of driving timing according to the number of gray scale bits or the number of scan lines is necessary to display a gray scale more exactly.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A method of driving a display apparatus which includes a plurality of pixel circuits corresponding to a plurality of data lines and a plurality of scan lines, a scan line driving circuit to supply a scan signal to each of the scan lines to exclusively select the scan lines in each of a plurality of horizontal periods, and a data line driving circuit to provide the data lines with data signals for turning on or off the pixel circuits to supply the data signal to a selected pixel circuit connected to one selected from the scan lines, and to display an image on a display screen with a plurality of gray scales by switching the pixel circuits into an on state or an off state in each of a plurality of sub-frames in one frame, the method comprising:
setting a pulse width for each of the sub-frames based on one or more horizontal periods; and
setting a number of the horizontal periods in each of the sub-frames such that a remainder is 1 horizontal period, when a total number of horizontal periods is divided by the number of sub-frames.

2. The method as claimed in claim 1, wherein:
when a predetermined number of horizontal periods of the sub-frame corresponds to 1 unit, the method includes setting sub-frames to correspond to the horizontal periods in the 1 unit,
in each horizontal period, a data signal of a corresponding one of the sub-frames is supplied to the data lines, so as to be supplied to the selected pixel circuit connected to a selected one of the scan lines, and
the 1 unit is iterated sequentially in the frame.

3. The method as claimed in claim 2, wherein:
when a number of scan lines is greater than a value of a number of gray scales plus 1, a number of units in the frame equals a number of scan lines.

4. The method as claimed in claim 2, wherein:
when a number of scan lines is not greater than a value of a number of gray scales plus 1, a number of units in the frame is set with a value of the number of scan lines plus 1.

5. The method as claimed in claim 2, wherein:
when a value of the number of units in the frame minus 1 is not an integer multiple of the number of gray scales, the pixel circuits are always turned off in one of the plurality of sub-frames.

6. The method as claimed in claim 5, wherein, a pulse width of one or more of the sub-frames in which the pixel circuits are always turned off is set with a horizontal period corresponding to pulse widths of remaining ones of the sub-frames other than the one or more sub-frames in which the pixel circuits are always turned off, minus a product of the number of units in the frame and the number of sub-frames in the frame.

7. A display apparatus, comprising:
a plurality of pixel circuits corresponding to a plurality of data lines and a plurality of scan lines;
a scan line driving circuit to supply a scan signal to each of the scan lines to exclusively select the scan lines in each of a plurality of horizontal periods; and
a data line driving circuit to provide the data lines with data signals for turning on or off the pixel circuits, each of the data signals to be supplied to a selected pixel circuit connected to a selected one of the scan lines, wherein:
an image on a display screen for displaying a plurality of gray scale values is displayed by switching the pixel circuits to an on state or an off state in each of a plurality of sub-frames in one frame;
a pulse width of each of the sub-frames is set based on one or more horizontal periods; and
a number of horizontal periods of a pulse width of each of the sub-frames is set such that a remainder is 1 horizontal period when a total number of horizontal periods is divided by a number of the sub-frames.

8. The apparatus as claimed in claim 7, wherein:
when a few of horizontal periods of the sub-frame is defined as 1 unit, sub-frames corresponding to horizontal periods in the 1 unit are set,
in each horizontal period, a data signal of a corresponding one of the sub-frames is supplied to the data lines, so as to be supplied to the selected pixel circuit connected to the selected scan line, and the 1 unit is iterated sequentially in the frame.

9. A method for driving a display apparatus, comprising:
setting a pulse width in a number of sub-frames of a frame based on a number of horizontal periods, a scan signal to be supplied to exclusively select at least one scan line of a plurality of scan lines in each of the horizontal periods; and
setting the number of the horizontal periods based on a pulse width of each of the sub-frames, the number of horizontal periods set to a value corresponding to a quotient generated by dividing the number of horizontal periods by the number of sub-frames with a remainder is 1 horizontal period.

10. The method as claimed in claim 9, wherein:
when a predetermined number of the horizontal periods corresponds to 1 unit, sub-frames corresponding to each of the horizontal period in the 1 unit are set; and
in each horizontal period, a data signal of a corresponding sub-frame is supplied to the data lines so as to be supplied to the selected pixel circuit connected to the selected scan line.

11. The method as claimed in claim 10, further comprising:
sequentially iterating the 1 unit in the frame.

12. The method as claimed in claim 10, wherein:
when a number of scan lines is greater than a value of a number of gray scales plus 1, a number of units in the frame corresponds to a number of scan lines.

13. The method as claimed in claim 10, wherein:
when a number of scan lines is not greater than a value of a number of gray scales plus 1, a number of units in the frame is set with a value of the number of scan lines plus 1.

14. The method as claimed in claim 10, wherein:
when a value of the number of units in the frame minus 1 is not an integer multiple of the number of gray scales, pixel circuits are always turned off in one of the plurality of sub-frames.

15. The method as claimed in claim 14, wherein a pulse width of the sub-frame in which the pixel circuits are always turned off is set with a horizontal period corresponding to pulse widths of remaining sub-frames other than the sub-frame, in which the pixel circuits are always turned off, minus a product of the number of units in the frame and the number of sub-frames in the frame.
